(19) United States
(12) Patent Application Publication
(10) Pub. No.: US 2016/0362141 A1
(43) Pub. Date: Dec. 15, 2016

(54) VEHICLE SIDE PORTION STRUCTURE

(71) Applicant: TOYOTA JIDOSHA KABUSHIKI KAISHA, Toyota-shi (JP)

(72) Inventor: Takashi HASEGAWA, Ashigarakami-gun (JP)

(73) Assignee: TOYOTA JIDOSHA KABUSHIKI KAISHA, Toyota-shi (JP)

(21) Appl. No.: 15/139,369

(22) Filed: Apr. 27, 2016

(30) Foreign Application Priority Data
Jun. 10, 2015 (JP) 2015-117431

(51) Int. Cl. B62D 21/15; B62D 25/04; B60R 21/213

(52) U.S. Cl. CPC B62D 21/157; B60R 21/213; B62D 25/04

(57) ABSTRACT

The outer R/F 28 is structured by a member whose strength is higher than and whose ductility is lower than those of the pillar inner panel 26 and the pillar outer panel 24, and has a vertical wall portion 28B that is disposed at a front side in a vehicle longitudinal direction and a vertical wall portion 28C that is disposed at a rear side. Further, a through-hole 32 is formed in the outer R/F 28 at a position that is further toward a vehicle vertical direction lower side than a beltline B and that overlaps a neutral plane M in a planar cross-section that includes the vertical wall portion 28B and the vertical wall portion 28C. The outer R/F 28 is joined to the pillar outer panel 24 at an interior of the closed cross-section, and reinforces the pillar outer panel 24.

### CROSS-REFERENCE TO RELATED APPLICATION

This application is based on and claims priority under 35 USC 119 from Japanese Patent Application No. 2015-117431 filed Jun. 10, 2015, the disclosure of which is incorporated by reference herein.

### TECHNICAL FIELD

The present invention relates to a vehicle side portion structure.

### RELATED ART

Japanese Patent Application Laid-Open (JP-A) No. 2008-189296 discloses a vehicle body side portion structure in which through-holes that are weak portions are provided at front and rear walls at the lower end portion of the pillar outer of a center pillar, and that has a bent portion at the lower portion of the pillar inner. In the vehicle body side portion structure of JP-A No. 2008-189296, at the time when the vehicle receives impact from the side due to a side collision, the pillar outer is broken into upper and lower parts with the through-holes being the starting points of the breakage.

Further, after the pillar outer breaks, tension is generated due to the bent portion of the pillar inner extending and entering into a completely extended state, and the speed of movement of the center pillar toward the vehicle cabin interior is reduced.

### SUMMARY

However, the above-described prior art is a structure that, in the initial stage of a side collision, proactively breaks the pillar outer at the region of the through-holes, and permits vehicle body deformation. Therefore, the amount of deformation of the center pillar toward the vehicle cabin side at the time of a side collision is great. Accordingly, there is room for improvement in suppressing deformation of a pillar toward the vehicle cabin inner side at the time of a side collision.

In view of the above-described circumstances, an object of the present invention is to provide a vehicle side portion structure that can suppress deformation of a pillar toward the vehicle cabin inner side at the time of a side collision.

A vehicle side portion structure relating to a first aspect includes: a pillar at which a closed cross-section is formed by a pillar inner and a pillar outer that are structured by ordinary steel sheets that are each ductile; and a reinforcing member that is structured by a member having a strength that is higher than and a ductility is lower than a strength and ductility of each of the pillar inner and the pillar outer, and that has a front wall disposed at a front side in a vehicle longitudinal direction and a rear wall disposed at a rear side in the vehicle longitudinal direction, and, in at least one of the front wall or the rear wall, a hole portion that passes-through the reinforcing member in the vehicle longitudinal direction being formed at a position that is further toward a lower side in a vehicle vertical direction than a beltline of a vehicle and that overlaps a neutral plane that runs along the vehicle longitudinal direction in a planar cross-section that includes the front wall and the rear wall, and the reinforcing member being joined to the pillar outer at an interior of the closed cross-section and reinforcing the pillar outer.

In the vehicle side portion structure relating to the first aspect, in the initial stage of a side collision to the vehicle, the reinforcing member that is made to have higher strength than the pillar outer resists the collision load. Due thereto, a high reaction force is obtained as compared with a case in which there is no reinforcing member, and therefore, deformation of the pillar toward the vehicle cabin inner side is suppressed.

In the middle stage of a side collision to the vehicle and thereafter, accompanying the deformation of the pillar outer and the pillar inner, there is the possibility that breakage will arise at the vehicle transverse direction inner side end edge of the front wall and/or the rear wall of the reinforcing member. Here, the progression of a crack from the vehicle transverse direction inner side end edge of the front wall and/or the rear wall of the reinforcing member toward the vehicle transverse direction outer side portion is suppressed due to the crack reaching the hole portion and the concentration of stress at the distal end of the crack being released. Due thereto, the collision energy that is absorbed at the vehicle side portion structure increases as compared with a structure that does not have the present structure. Further, in a case in which breakage arises at a portion of the reinforcing member, reaction force is sustained due to the pillar outer and the pillar inner, that have higher ductilities than the reinforcing member, resisting the collision load. In this way, in the middle stage of a side collision to the vehicle and thereafter, the collision energy that is absorbed at the reinforcing member and the pillar increases and the reaction force is sustained, and therefore, deformation of the pillar toward the vehicle cabin inner side is suppressed.

Moreover, at the reinforcing member, the hole portion is formed, in at least one of the front wall and the rear wall, at a position that overlaps a neutral plane that runs along the vehicle longitudinal direction in a planar cross-section that includes the front wall and the rear wall. In other words, the hole portion is formed at a position that overlaps a neutral plane that is the border between the region where tensile stress is applied to the reinforcing member and the region where compressive stress is applied, at the time of a side collision. Here, in a vicinity of the neutral plane, the stress that is applied is zero or is extremely small, and therefore, it is difficult for the reinforcing member to deform. Namely, in a case in which a crack arises in the reinforcing member, due to the crack reaching the hole portion, not only is the progression of the crack suppressed, but also, deformation of the edge of the hole portion is suppressed. Therefore, deformation of the pillar toward the vehicle cabin inner side is suppressed.

In addition, the hole portion is formed further toward the vehicle vertical direction lower side of the reinforcing member than the beltline of the vehicle. The region, that is further toward the vehicle vertical direction lower side than the beltline of the vehicle, at the reinforcing member is the region that is most easily deformed at the time of a side collision. Namely, at the reinforcing member, the hole portion is formed in the region that deforms most easily at the time of a side collision. Therefore, even if a crack arises in the reinforcing member, the concentration of stress at the distal end of the crack of the reinforcing member is released by the hole portion, and progression of the crack of the reinforcing member is suppressed. Due thereto, at the vehicle side portion structure, deformation of the pillar toward the vehicle cabin inner side at the time of a side collision is suppressed, as compared with a structure in which a hole portion is not formed further toward the vehicle vertical direction lower side of the reinforcing member than the beltline of the vehicle. Note that high tensile strength steel sheets and hot stamped materials are examples of members whose strength is higher than and whose ductility is lower than those of the pillar inner and the pillar outer.

At the hole portion of a vehicle side portion structure relating to a second aspect, a length of the hole portion in the vehicle vertical direction is set to be longer than a length of the hole portion in a vehicle transverse direction, as seen in the vehicle longitudinal direction.

In the vehicle side portion structure relating to the second aspect, the length of the hole portion in the vehicle vertical direction is set to be longer than the length in the vehicle transverse direction. Here, a crack, that arises at the vehicle transverse direction inner side end edge of the front wall and/or the rear wall of the reinforcing member in a side collision, progresses toward the vehicle cabin outer side. However, because the hole portion is long in the vehicle vertical direction, it is possible for the crack to reach the hole portion even in a case in which the crack progresses in an inclined direction that intersects the vehicle transverse direction.

A side airbag, that inflates and expands at a time of a side collision, is accommodated in a side door or in a seat transverse direction side portion of a vehicle seat of a vehicle side portion structure relating to a third aspect, and, in a case when the side airbag inflates and expands, the side airbag is disposed between the pillar and a side portion of a vehicle occupant who is seated in the vehicle seat.

In the vehicle side portion structure relating to the third aspect, due to deformation of the pillar toward the vehicle cabin inner side at the time of a side collision being suppressed by the pillar and the reinforcing member, the interval between the pillar and the side portion of the vehicle occupant who is seated in the vehicle seat is ensured. Further, the side airbag is inflated and expanded between the pillar and the side portion of the vehicle occupant seated in the vehicle seat. In this way, the interval between the pillar and the side portion of the vehicle occupant seated in the vehicle seat is ensured, and the side airbag is inflated and expanded. Therefore, reduction of the inflation and expansion region of the side airbag can be suppressed.

In the vehicle side portion structure relating to the forth aspect, the reinforcing member is joined to the pillar outer at a region further toward the vehicle transverse direction inner side than the hole portion.

According to the forth aspect of the vehicle side portion structure, the reinforcing member receives the collision load at a region further toward the vehicle transverse direction inner side than the hole portion. Therefore, the collision energy is effectively absorbed.

### Advantageous Effects of Invention

As described above, in accordance with the vehicle side portion structure relating to the first aspect, the excellent effect is obtained that deformation of the pillar toward the vehicle cabin inner side at the time of a side collision can be suppressed.

In accordance with the vehicle side portion structure relating to the second aspect, the excellent effect is obtained that, even in a case in which a crack in the front wall and/or the rear wall of the reinforcing member progresses in an inclined direction that intersects the vehicle transverse direction, the crack is made to reach the hole portion, and progression of the crack can be suppressed.

In accordance with the vehicle side portion structure relating to the third aspect, the excellent effect is obtained that a reduction in the inflation and expansion region of the side airbag can be suppressed.

### BRIEF DESCRIPTION OF THE DRAWINGS

Embodiments of the present invention will be described in detail based on the following figures, wherein:

FIG. 1 is a structural drawing showing a vehicle to which a vehicle side portion structure relating to a present embodiment is applied;

FIG. 2 is a side view in which a center pillar relating to the present embodiment and a seat are viewed from a vehicle cabin outer side;

FIG. 3 is an enlarged perspective view in which a portion of the center pillar relating to the present embodiment is enlarged;

FIG. 4 is a horizontal sectional view (the cross-section along line 4-4 of FIG. 1 and the cross-section along line 4-4 of FIG. 3) of the center pillar relating to the present embodiment;

FIG. 5 is an explanatory drawing that shows the placement of a through-hole of a reinforcement relating to the present embodiment;

FIG. 6 is an explanatory drawing showing the state at the time of a side collision at the vehicle to which the vehicle side portion structure relating to the present embodiment is applied;

FIG. 7 is an enlarged perspective view showing a deformed state of a portion of the center pillar at the time of a side collision at the vehicle side portion structure relating to the present embodiment;

FIG. 8A is a graph showing the relationship between amount of displacement in the vehicle transverse direction of the center pillar and stress applied to the center pillar, relating to the present embodiment and first and second comparative examples;

FIG. 8B is a graph showing the relationship between time and speed in the deforming, in the vehicle transverse direction, of the center pillar, relating to the present embodiment and the first and second comparative examples;

FIG. 9 is an explanatory drawing showing the placement of a through-hole of the reinforcement relating to a modified example of the present embodiment;

FIG. 10A is an explanatory drawing showing a deformed state of a portion of the center pillar of the first comparative example; and

FIG. 10B is an explanatory drawing showing a deformed state of a portion of the center pillar of the second comparative example.

### DETAILED DESCRIPTION OF THE INVENTION

An example of an embodiment of a vehicle side portion structure relating to the present invention is described hereinafter. Note that arrow FR that is shown appropriately in the respective drawings indicates the vehicle forward direction (the advancing direction), arrow RR indicate the vehicle rearward direction, arrow UP indicates the vehicle upward direction, arrow IN indicates the vehicle transverse direction inner side, and arrow OUT indicates the vehicle transverse direction outer side. Hereinafter, when merely longitudinal, vertical and left-right directions are used, they indicate the longitudinal of the vehicle longitudinal direction, the vertical of the vehicle vertical direction, and the left and right of the vehicle transverse direction in a case of facing in the advancing direction, unless otherwise indicated. Further, the “X” marks in the drawings indicate places that are spot welded.

[Overall Structure]

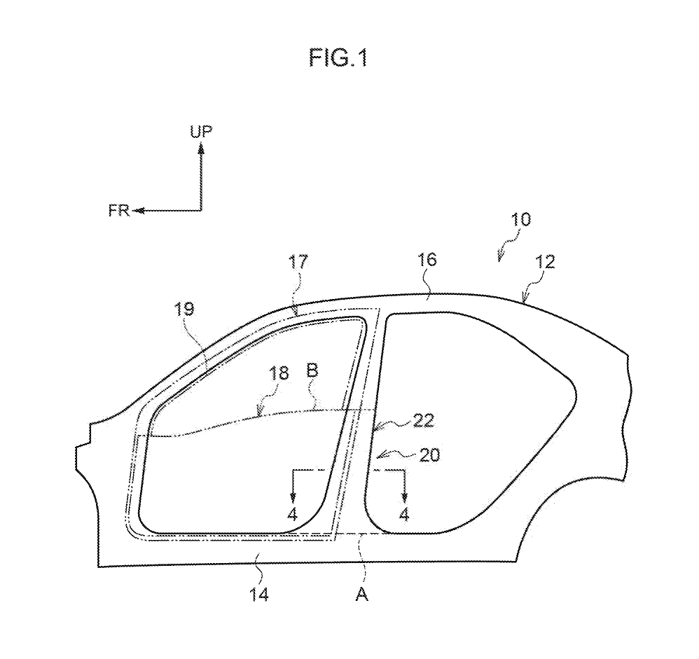

A portion of the left side portion of a vehicle 10 is shown in FIG. 1. The vehicle 10 has a vehicle body 12 that includes rockers 14, roof side rails 16, side doors 17 and vehicle side portion structures 20. The rockers 14 extend in the vehicle longitudinal direction at the vehicle lower portion of the vehicle body 12. Further, the line that represents the top end in the vehicle vertical direction of the rocker 14 is shown by the dashed line that is designated as line A. The roof side rails 16 extend in the vehicle longitudinal direction at the vehicle upper portion of the vehicle body 12. Note that, in FIG. 1, the outer shape of the side door 17 at the front side in the vehicle longitudinal direction is shown by the two-dot chain line, and illustration of the side door at the rear side is omitted.

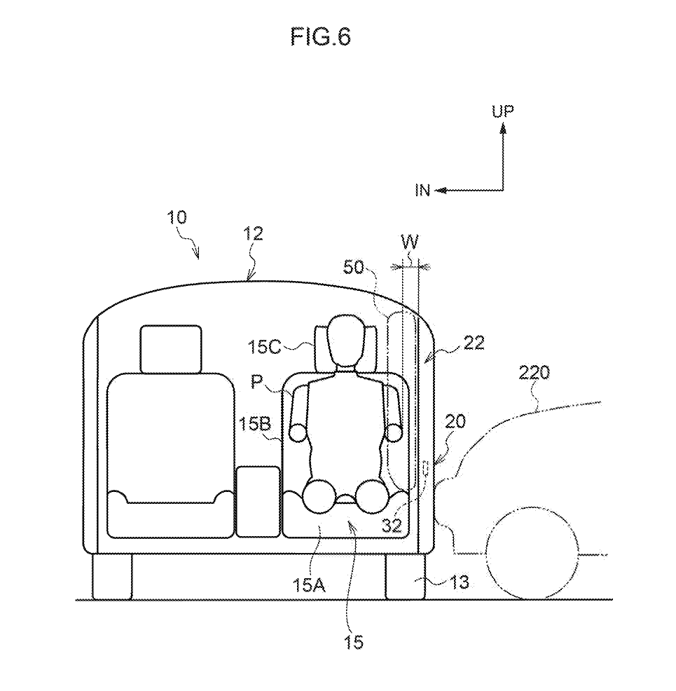

The side door 17 is structured to include an inner panel and an outer panel (collectively called “door panels 18” hereinafter) and a side window 19. A side airbag 50 (see FIG. 6) is accommodated in the side door 17. The side airbag 50 is structured such that, when the side airbag 50 is inflated and expanded by an unillustrated inflator at the time of a side collision, the side airbag 50 is disposed between a center pillar 22 that is described later and the side portion of a vehicle occupant P (see FIG. 6) who is seated in a vehicle seat 15. Here, the line that goes-through the upper end in the vehicle vertical direction of the door panels 18 is designated as beltline B.

Note that, as an example, the vehicle body 12 and the vehicle side portion structures 20 are structured so as to have left-right symmetry with respect to an unillustrated axis of symmetry that extends in the vehicle longitudinal direction at the vehicle transverse direction center. Therefore, in the following description, the vehicle side portion structure 20 at the left side of the vehicle 10 is described, and description of the vehicle side portion structure 20 at the right side is omitted.

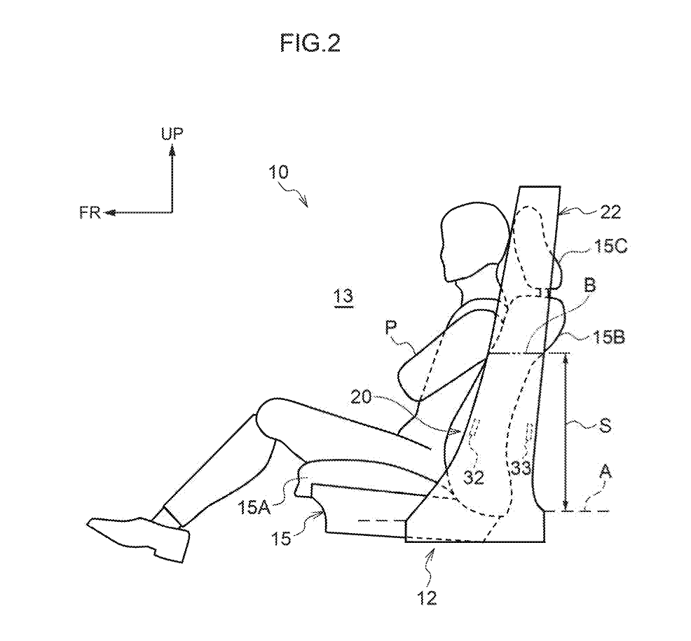

The relationship of the arrangement between the vehicle seat 15 that is provided at the vehicle 10 and the center pillar 22 that is described later is shown in FIG. 2.

The vehicle seat 15 is a front seat of the vehicle 10 (as an example, is the driver's seat of a left-hand drive vehicle), and is disposed at the front portion of a vehicle cabin 13. Further, the vehicle seat 15 is structured to include a seat cushion 15A on which the vehicle occupant P sits, a seatback 15B that is the backrest of the vehicle occupant P, and a headrest 15C that supports the head portion of the vehicle occupant P. The seat cushion 15A is connected to the floor of the vehicle body 12 via a slide mechanism (neither the floor nor the slide mechanism is illustrated), and the longitudinal position of the seat cushion 15A with respect to the floor can be adjusted. Note that, in FIG. 2, the vehicle occupant P is shown as dummy P.

The position of the vehicle seat 1S at the time when the vehicle occupant P is in a standard seated position that is prescribed by crash test methods, is the standard position. In the state in which the vehicle seat 15 is disposed at the standard position, as an example, the center pillar 22 is positioned at the vehicle transverse direction outer side of the seatback 15B. Further, in the present embodiment, as an example, the vehicle side portion structure 20 is provided within a set region S that is further toward the lower side in the vehicle vertical direction than the beltline B and is further toward the upper side in the vehicle vertical direction than the line A.

[Vehicle Side Portion Structure]

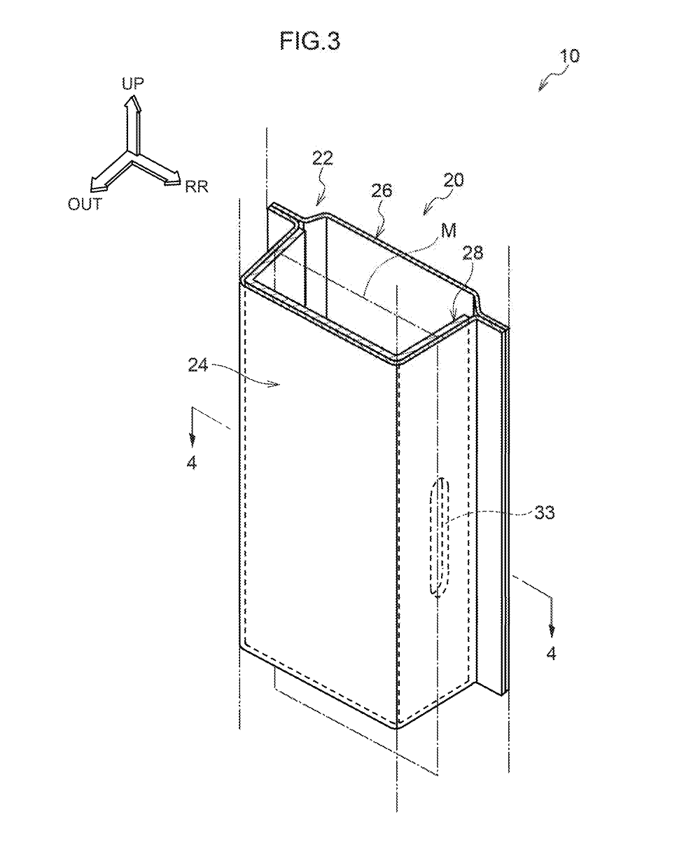

As shown in FIG. 3, the vehicle side portion structure 20 has the center pillar 22 that serves as an example of a pillar, and a center pillar outer reinforcement 28 that serves as an example of a reinforcing member. Note that, in the following explanation, the center pillar outer reinforcement 28 is called the outer R/F 28.

<Center Pillar>

As shown in FIG. 1, the vehicle vertical direction lower end portion of the center pillar 22 is joined by welding to rocker 14, and the center pillar 22 extends from the vehicle longitudinal direction central portion of the rocker 14 toward the upper side in the vehicle vertical direction. Further, the vehicle longitudinal direction central portion of the roof side rail 16 is joined by welding to the upper end portion of the center pillar 22. Moreover, an unillustrated side member outer panel, that structures the design surface of the vehicle 10, is provided at the vehicle transverse direction outer side of the center pillar 22.

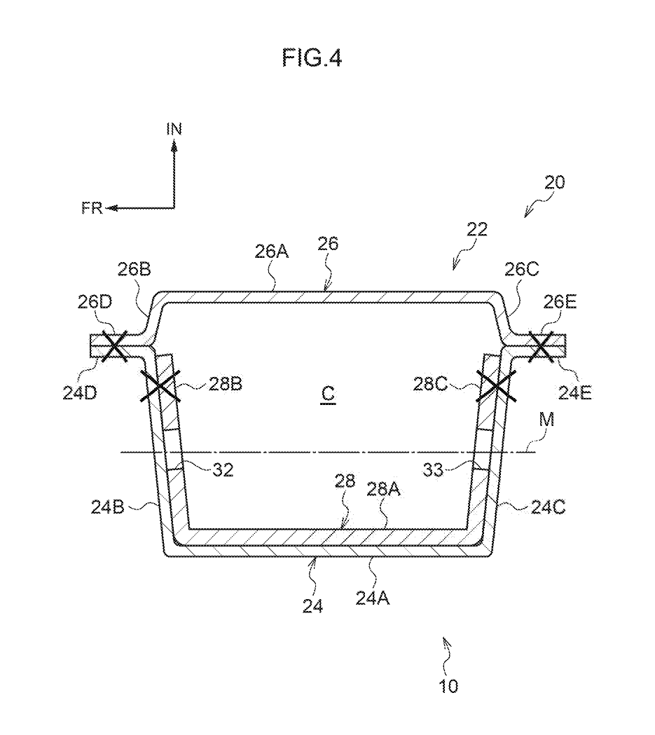

As shown in FIG. 4, the center pillar 22 has a pillar outer panel 24 that is disposed at the vehicle transverse direction outer side, and a pillar inner panel 26 that is disposed at the vehicle transverse direction inner side. The pillar outer panel 24 is an example of a pillar outer. The pillar inner panel 26 is an example of a pillar inner.

(Pillar Outer Panel)

The pillar outer panel 24 is formed by press-working an ordinary steel sheet that is ductile. Note that “ordinary steel” is made of iron (Fe) which includes five elements C, Si, Mn, P, and S. The cross-sectional shape, as seen in the vehicle vertical direction, of the pillar outer panel 24 is formed in the shape of a hat that opens toward the vehicle transverse direction inner side. Further, the pillar outer panel 24 is more ductile than the outer R/I 28. Being ductile means that the strain from the start of application of load until breakage is great. Moreover, as an example, the tensile strength of the pillar outer panel 24 is higher than that of the pillar inner panel 26 that is described later. In addition, the pillar outer panel 24 has a base portion 24A, a vertical wall portion 24B, a vertical wall portion 24C, a flange 24D and a flange 24E.

The base portion 24A is formed in the shape of a plate whose plate surface runs along the vehicle longitudinal direction. The vertical wall portion 24B extends toward the vehicle transverse direction inner side from the vehicle longitudinal direction front end portion of the base portion 24A such that, as seen in the vehicle transverse direction, the vehicle transverse direction inner side end portion thereof is positioned further toward the vehicle longitudinal direction front side than the vehicle transverse direction outer side end portion thereof. The vertical wall portion 24C extends toward the vehicle transverse direction inner side from the vehicle longitudinal direction rear end portion of the base portion 24A such that, as seen in the vehicle transverse direction, the vehicle transverse direction inner side end portion thereof is positioned further toward the vehicle longitudinal direction rear side than the vehicle transverse direction outer side end portion thereof. The flange 24D extends toward the vehicle longitudinal direction front side from the vehicle transverse direction inner side end portion of the vertical wall portion 24B. The flange 24E extends toward the vehicle longitudinal direction rear side from the vehicle transverse direction inner side end portion of the vertical wall portion 24C.

(Pillar Inner Panel)

The pillar inner panel 26 is formed by press-working an ordinary steel sheet that is ductile. The cross-sectional shape, as seen in the vehicle vertical direction, of the pillar inner panel 26 is formed in the shape of a hat that opens toward the vehicle transverse direction outer side. Further, the pillar inner panel 26 is more ductile than the outer R/F 28. Moreover, the pillar inner panel 26 has a base portion 26A, a vertical wall portion 26B, a vertical wall portion 26C, a flange 26D and a flange 26E.

The base portion 26A is formed in the shape of a plate whose plate surface runs along the vehicle longitudinal direction. The vertical wall portion 26B extends toward the vehicle transverse direction outer side from the vehicle longitudinal direction front end portion of the base portion 26A such that, as seen in the vehicle transverse direction, the vehicle transverse direction outer side end portion thereof is positioned further toward the vehicle longitudinal direction front side than the vehicle transverse direction inner side end portion thereof. The vertical wall portion 26C extends toward the vehicle transverse direction outer side from the vehicle longitudinal direction rear end portion of the base portion 26A such that, as seen in the vehicle transverse direction, the vehicle transverse direction outer side end portion thereof is positioned further toward the vehicle longitudinal direction rear side than the vehicle transverse direction inner side end portion thereof. The flange 26D extends toward the vehicle longitudinal direction front side from the vehicle transverse direction outer side end portion of the vertical wall portion 26B. The flange 26E extends toward the vehicle longitudinal direction rear side from the vehicle transverse direction outer side end portion of the vertical wall portion 26C.

Here, at the center pillar 22, the flange 24D and the flange 26D, and the flange 24E and the flange 26E, are respectively joined by spot welding, and form a closed cross-section (space C). Note that through-holes, that correspond to through-holes 32, 33 of the outer R!F 28 that is described hereinafter, are not formed in the pillar outer panel 24 and the pillar inner panel 26 within the above-described set range S (see FIG. 2).

<Outer R/F>

The outer R/F 28 is formed by press-working a high tensile strength steel sheet as an example. The cross-sectional shape of the outer R/F 28 as seen in the vehicle vertical direction is formed in the shape of a hat that opens toward the vehicle transverse direction inner side. Note that a high tensile strength steel sheet means a steel sheet whose tensile strength is higher than that of an ordinary steel sheet, and mainly means a steel sheet whose tensile strength is greater than or equal to 440 MPa. Further, an ultrahigh tensile strength steel sheet means a high tensile strength steel sheet whose tensile strength is greater than or equal to 980 MPa. Due to the outer R/F 28 being structured by a high tensile strength steel sheet in this way, the outer R/F 28 has the properties that the strength thereof is higher than and the ductility thereof is lower than those of the pillar outer panel 24 and the pillar inner panel 26. Further, the outer R/F 28 has a base portion 28A, a vertical wall portion 28B that serves as an example of a front wall, and a vertical wall portion 28C that serves as an example of a rear wall.

The base portion 28A is formed in the shape of a plate whose plate surface runs along the vehicle longitudinal direction. Further, the length of the base portion 28A in the vehicle longitudinal direction is shorter than the length of the base portion 24A in the vehicle longitudinal direction. The vertical wall portion 28B extends toward the vehicle transverse direction inner side from the vehicle longitudinal direction front end portion of the base portion 28A such that, as seen in the vehicle transverse direction, the vehicle transverse direction inner side end portion thereof is positioned further toward the vehicle longitudinal direction front side than the vehicle transverse direction outer side end portion thereof. The vertical wall portion 28C extends toward the vehicle transverse direction inner side from the vehicle longitudinal direction rear end portion of the base portion 28A such that, as seen in the vehicle transverse direction, the vehicle transverse direction inner side end portion thereof is positioned further toward the vehicle longitudinal direction rear side than the vehicle transverse direction outer side end portion thereof.

The lengths of the vertical wall portion 28B and the vertical wall portion 28C in the vehicle transverse direction are shorter than the lengths of the vertical wall portion 24B and the vertical wall portion 24C in the vehicle transverse direction, and as an example, are substantially the same lengths. The through-hole 32, that serves as an example of a hole portion that passes-through in the vehicle longitudinal direction, is formed in the vertical wall portion 28B. The through-hole 33, that serves as an example of a hole portion that passes-through in the vehicle longitudinal direction, is formed in the vertical wall portion 28C. Note that, as an example, the shapes, sizes, formed numbers, and formed positions in the vehicle transverse direction and the vehicle vertical direction of the through-hole 32 and the through-hole 33 are the same. Therefore, there are cases in which the through-hole 32 is described and description of the through-hole 33 is omitted.

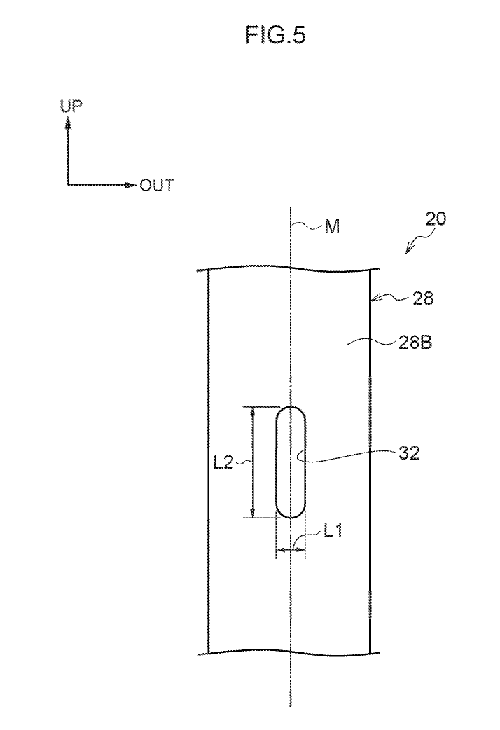

The through-hole 32 shown in FIG. 5 is, as an example, formed at one place in the vertical wall portion 28B within the above-described set region S (see FIG. 2). Namely, the through-hole 32 is formed further toward the vehicle vertical direction lower side than the beltline B (see FIG. 2) and further toward the upper side than the line A (see FIG. 2), at the outer R/F 28. Concretely, the through-hole 32 is formed at a height position, that is in the vicinity of the waist of the vehicle occupant P (see FIG. 2), at the vertical wall portion 28B.

Further, the through-hole 32 is made to be a long hole at which length L2 in the vehicle vertical direction is longer than length L1 in the vehicle transverse direction (the length L2 is set to be longer than the length L1), when the vertical wall portion 28B is viewed in the vehicle longitudinal direction. Moreover, the hole wall surfaces at the vehicle vertical direction central portion of the through-hole 32 are made to be flat surfaces that extend along the vehicle vertical direction, and the hole wall surfaces of the vehicle vertical direction upper end portion and lower end portion are made to be curved surfaces that are arc-shaped.

As shown in FIG. 4, the through-holes 32, 33 are formed at positions that overlap a neutral plane M (shown by the one-dot chain line M) that is a cross-section (a planar cross-section) in the vehicle longitudinal direction and the vehicle transverse direction that includes the base portion 28A, the vertical wall portion 28B and the vertical wall portion 28C. The neutral plane M is a virtual plane at which compressive strain and tensile strain do not arise at the time when external force in the vehicle transverse direction is applied to the outer R/F 28 (i.e., there is no change in the length in the axial direction between before deformation and after deformation). As an example, the neutral plane M is positioned at the vehicle transverse direction centers of the vertical wall portions 28B, 28C. Further, the neutral plane M is a virtual plane that runs along the vehicle longitudinal direction.

Further, the outer R/F 28 is disposed at the interior of the closed cross-section (the space C) of the center pillar 22. The base portion 28A and the base portion 24A, and the vertical wall portion 28B and the vertical wall portion 24B, and the vertical wall portion 28C and the vertical wall portion 24C, respectively contact one another. The vehicle transverse direction inner side end portion (the region further toward the vehicle transverse direction inner side than the through-hole 32) of the vertical wall portion 28B is overlapped on the vertical wall portion 24B from the vehicle longitudinal direction rear side, and is joined to the vehicle transverse direction inner side end portion of the vertical wall portion 24B by spot welding. The vehicle transverse direction inner side end portion (the region further toward the vehicle transverse direction inner side than the through-hole 33) of the vertical wall portion 28C is overlapped on the vertical wall portion 24C from the vehicle longitudinal direction front side, and is joined to the vehicle transverse direction inner side end portion of the vertical wall portion 24C by spot welding. In this way, the outer R/F 28 is joined to the pillar outer panel 24 at the interior of the closed cross-section of the center pillar 22, and reinforces the pillar outer panel 24.

### Comparative Examples

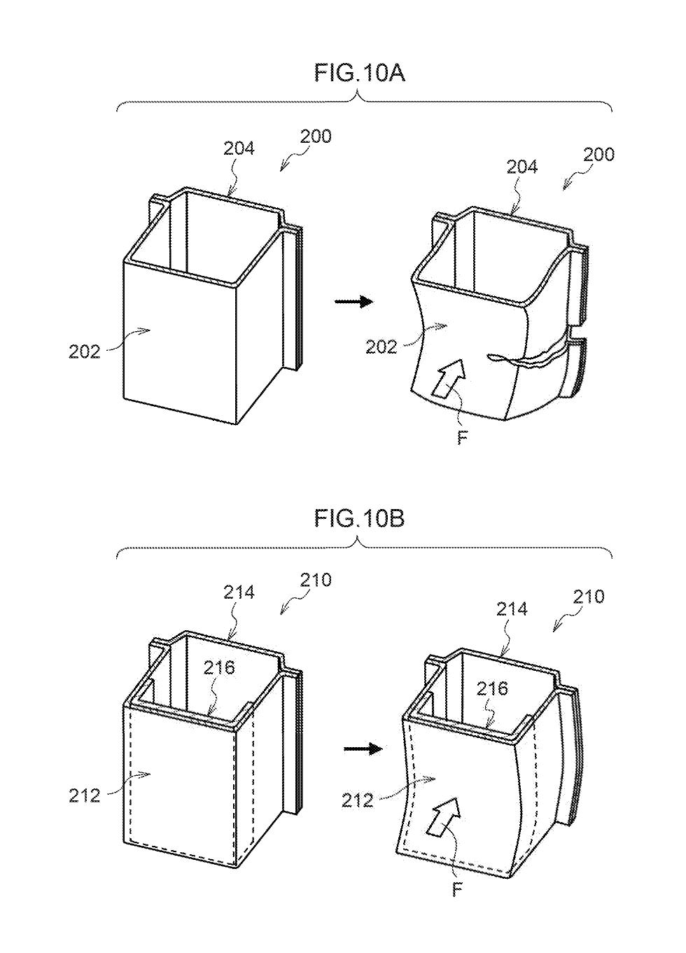

A center pillar 200 of a first comparative example with respect to the present embodiment is shown in FIG. 10A. The center pillar 200 has a pillar outer panel 202 and a pillar inner panel 204. As seen in the vehicle vertical direction, the pillar outer panel 202 is formed in the shape of a hat in cross-section, that opens toward the vehicle transverse direction inner side. As seen in the vehicle vertical direction, the pillar inner panel 204 is formed in the shape of a hat in cross-section, that opens toward the vehicle transverse direction outer side. The pillar outer panel 202 and the pillar inner panel 204 are structured by hot stamped materials that are formed by hot stamping.

A center pillar 210 of a second comparative example with respect to the present embodiment is shown in FIG. 10B. The center pillar 210 has a pillar outer panel 212, a pillar inner panel 214 and an outer R/F 216. As seen in the vehicle vertical direction, the pillar outer panel 212 is formed in the shape of a hat in cross-section, that opens toward the vehicle transverse direction inner side. As seen in the vehicle vertical direction, the pillar inner panel 214 is formed in the shape of a hat in cross-section, that opens toward the vehicle transverse direction outer side. The pillar outer panel 212 and the pillar inner panel 214 are structured are structured by ordinary steel sheets. The outer R/F 216 is structured by a hot stamped material that is formed by hot stamping, and reinforces only the vehicle transverse direction outer side end portion of the pillar outer panel 212, and does not reinforce (is not provided at) the vehicle transverse direction central portion and inner side end portion of the pillar outer panel 212.

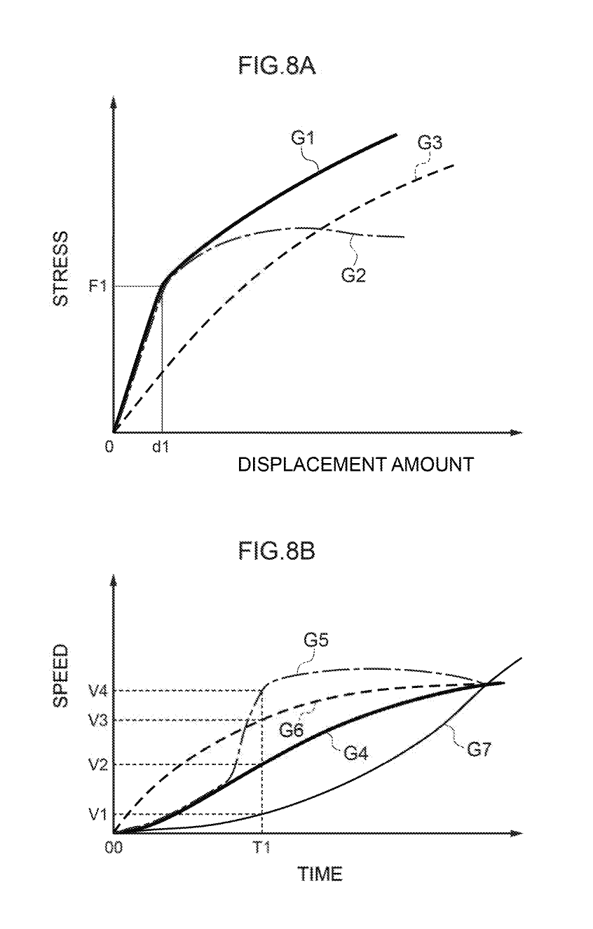

Here, the deformed states of the center pillar 200 and the center pillar 210, at the time when collision load F due to a side collision is applied to the center pillar 200 and the center pillar 210 as shown in FIG. 10A and FIG. 10B, are explained by using FIG. 8A and FIG. 8B. Note that the reference numerals of the respective members in the explanation that utilizes FIG. 8A and FIG. 8B are reference numerals that refer to FIG. 10A and FIG. 10B.

The relationship between displacement amount (strain) of the center pillar and stress that is applied to the center pillar is shown in FIG. 8A. Displacement amount d1 is the displacement amount of the center pillar 200 at the time when breakage of the center pillar 200 starts. As shown by graph G2, at the center pillar 200, due to the center pillar 200 being structured by hot stamped materials, the stress becomes stress F1 at the displacement amount d1, and a high reaction force is obtained from the time of the side collision (displacement amount d=0) until displacement amount d1. However, when the displacement amount becomes displacement amount d1 and breakage arises at a portion of the center pillar 200, it is difficult for the reaction force to increase thereafter.

The relationship between time that has elapsed from the time of the side collision (time T=0) and the speed of deformation of the center pillar is shown in FIG. 8B. Time point T1 represents the point in time when the inflation and expansion of the side airbag 50 (see FIG. 6) are completed. As shown by graph G5, at the center pillar 200, breakage starts immediately before time point T1, and the speed of the deformation increases sharply. Further, a state in which the speed of the deformation is high continues also after time point T1. In this way, at the center pillar 200 of the first comparative example, although a high reaction force is obtained at the initial stage of the side collision, the center pillar 200 breaks, and therefore, it is difficult to obtain a high reaction force on a continuing basis, and the speed of the deformation of the center pillar 200 also is high.

On the other hand, as shown by graph G3 of FIG. 5A, at the center pillar 210, it is difficult for the outer R/F 216 to work in the initial stage of the side collision, and therefore, at the pillar outer panel 212 and the pillar inner panel 214, there is resistance to the collision load. Therefore, at the center pillar 210, the reaction force that is obtained at the initial stage of the side collision is small as compared with at the center pillar 200. Further, at the center pillar 210, from the initial stage of the side collision and thereafter, reaction force due to the outer R/F 216 arises without breakage occurring, and the reaction force increases thereafter.

As shown by graph G6 of FIG. 8B, at the center pillar 210, before time point T1, the reaction force that is obtained is small, and therefore, the speed of deformation is faster than at the center pillar 200. However, after time point T1, the speed of the deformation becomes lower than that of the center pillar 200 due to the operation of the reaction force that is due to the outer R/F 216. In this way, at the center pillar 210 of the second comparative example, in the initial stage of a side collision, it is difficult to obtain a high reaction force, and the speed of the deformation is high.

<Operation and Effects>

Operation and effects of the vehicle side portion structure 20 of the present embodiment are described next.

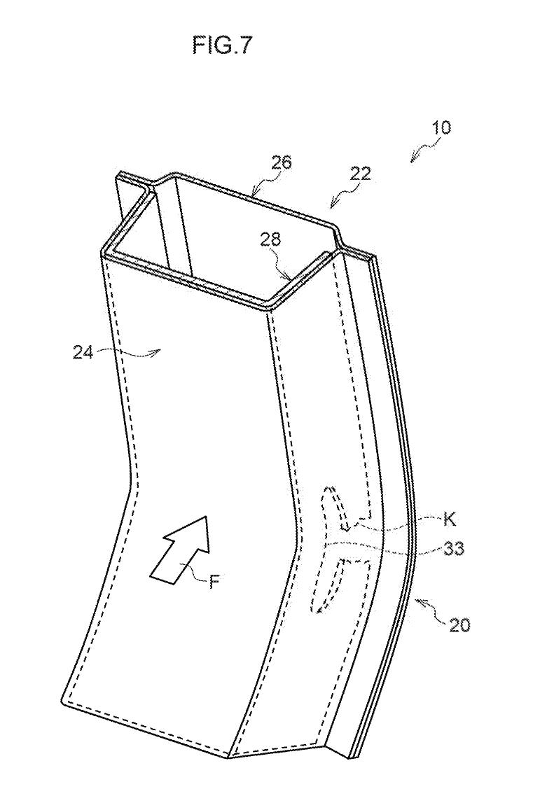

As shown in FIG. 6, as an example, description is given of a case in which another vehicle 220 side-collides with the left side portion (including the center pillar 22) of the vehicle 10. Due to the side collision with the other vehicle 220, the collision load F (refer to FIG. 7) acts on the center pillar 22 from the vehicle transverse direction outer side toward the inner side.

Deformation of the center pillar 22 and the outer R/F 28 (see FIG. 4) toward the vehicle cabin inner side starts from the point in time of the side collision. Further, due to the side collision being sensed by an unillustrated sensor and an unillustrated inflator operating, inflation and expansion of the side airbag 50 start. Note that the side airbag 50 shown in FIG. 6 is shown in its shape at the time when inflation and expansion are completed.

As shown in FIG. 4, the base portion 24A, the vertical wall portion 24B and the vertical wall portion 24C of the pillar outer panel 24 are reinforced by the outer R/F 28 that has higher strength than the pillar outer panel 24. Therefore, in the initial stage of the side collision to the vehicle 10, due to the outer R/F 28 resisting the collision load F (refer to FIG. 7), a high reaction force is obtained at the center pillar 22 as compared with a case in which there is no outer R/F 28. Due thereto, in the initial stage of a side collision to the vehicle 10, deformation of the center pillar 22 toward the vehicle cabin inner side can be suppressed.

Moreover, as shown in FIG. 6, due to deformation of the center pillar 22 being suppressed, an interval W between the center pillar 22 and the side portion of the vehicle occupant P seated in the vehicle seat 15 is ensured. Further, the side airbag 50 is inflated and expanded between the center pillar 22 and the side portion of the vehicle occupant P seated in the vehicle seat 15. In this way, the interval W between the center pillar 22 and the side portion of the vehicle occupant P seated in the vehicle seat 15 is ensured, and the side airbag 50 is inflated and expanded, and therefore, a reduction in the inflation and expansion region of the side airbag 50 can be suppressed.

As shown in FIG. 7, in the middle stage (the middle) of a side collision to the vehicle 10 and thereafter, accompanying the deformation of the pillar outer panel 24 and the pillar inner panel 26, the deformation of the outer R/F 28 also progresses. Because the ductility of the outer R/F 28 is lower than those of the pillar outer panel 24 and the pillar inner panel 26, there are cases in which cracks K arise in the vehicle transverse direction inner side end edges of the outer R/F 28. Further, the cracks K that arise in the vehicle transverse direction inner side end edges of the outer R/F 28 progress toward the vehicle cabin outer side, and reach the through-hole 32 (see FIG. 4) and the through-hole 33 (portions of the outer R/F 28 break).

The progression of the cracks K from the vehicle transverse direction inner side end edges at the outer R/F 28 toward the vehicle cabin outer side is suppressed due to the cracks K reaching the through-holes 32, 33 and the concentrations of stress at the distal ends in the progressing direction of the cracks K being released. Progression of the cracks K being suppressed means that a long time can be taken for the cracks K to progress. Namely, the time over which the collision energy is absorbed due to deformation of the outer R/F 28 becomes long. Due thereto, the collision energy that is absorbed at the vehicle side portion structure 20 can be increased as compared with the above-described first comparative example and second comparative example.

Further, even after the cracks K of the outer R/F 28 have reached the through-holes 32, 33, the pillar outer panel 24 and the pillar inner panel 26 whose ductilities are higher than that of the outer R/F 28 resist the collision load F. Moreover, energy absorption is carried out due to the vehicle transverse direction outer side portion of the pillar outer panel 24 contracting and the inner side portion extending, and the pillar inner panel 26 extending. In addition, the portion, that is further toward the vehicle transverse direction outer side than the through-holes 32, 33, of the outer R/F 28 reinforces the pillar outer panel 24. Due to these operations, the reaction force due to the vehicle side portion structure 20 is sustained, and energy absorption is carried out.

In this way, in the middle stage of a side collision to the vehicle 10 and thereafter, the collision energy that is absorbed at the outer R/F 28 and the center pillar 22 increases, and the reaction force with respect to the collision load F is sustained. Therefore, even in the middle stage of a side collision to the vehicle 10 and thereafter, deformation of the center pillar 22 toward the vehicle cabin inner side of the vehicle 10 can be suppressed.

Further, at the vehicle side portion structure 20, in the middle stage of a side collision and thereafter, because progression of the cracks K is suppressed by the through-holes 32, 33 (see FIG. 4), the speed of deformation of the center pillar 22 is lower than those of the above-described comparative example 1 and comparative example 2. As described above, at the vehicle side portion structure 20, deformation of the center pillar 22 toward the vehicle cabin inner side at the time of a side collision to the vehicle 10 can be suppressed.

Moreover, as shown in FIG. 2, at the vehicle side portion structure 20, the through-holes 32, 33 are formed at positions, that are lower in the vehicle vertical direction than the beltline B of the vehicle 10, of the outer R/F 28 (see FIG. 4). Here, the region that is further toward the vehicle vertical direction lower side than the beltline B at the outer R/F 28 (i.e., the region within the set region S) is the region that is most easily deformed at the time of a side collision. Namely, at the vehicle side portion structure 20, because the through-holes 32, 33 are formed in the outer R/F 28 at the region that deforms most easily at the time of a side collision, even if the cracks K (see FIG. 7) arise due to deformation, progression of the cracks K is suppressed by the through-holes 32, 33. Due thereto, deformation of the center pillar 22 toward the vehicle cabin inner side at the time of a side collision can be suppressed.

In addition as shown in FIG. 5, at the vehicle side portion structure 20, the length L2 in the vehicle vertical direction of the through-hole 32 is set to be longer than the length L1 in the vehicle transverse direction, as seen in the vehicle longitudinal direction. The same can be said for the through-hole 33 (see FIG. 4) as well. The cracks K (see FIG. 7), that arise at the vehicle transverse direction inner side end edges of the vertical wall portions 288, 28C (see FIG. 4) of the outer R/F 28 at the time of a side collision, progress toward the vehicle cabin outer side. Here, because the through-holes 32, 33 are long in the vehicle vertical direction, the cracks K can be made to reach the through-holes 32, 33 even in a case in which the cracks K progress in inclined directions that intersect the vehicle transverse direction (a case in which the distal ends of the cracks K progress toward the upper side or the lower side in the vehicle vertical direction with respect to the vehicle longitudinal direction).

Further, in a side collision, tensile load in the vehicle vertical direction is applied to the vehicle transverse direction inner side portion of the outer R/F 28. Here, the stress concentration factors at the edges of the through-holes 32, 33 are small as compared with a case in which the length L2 in the vehicle transverse direction is made to be longer than the length L1 in the vehicle vertical direction at the through-holes 32, 33. Due thereto, concentrations of stress at the edges of the through-holes 32, 33 are suppressed, and therefore, deformation of the center pillar 22 toward the vehicle cabin inner side at the time of a side collision can be suppressed.

To describe this further, in a case in which a hole that passes-through in the plate-thickness direction is formed in a plate-shaped member, when the member is tensed in one direction (the axial direction), stress becomes high locally at the edge (the periphery) of the hole. This phenomenon is called a concentration of stress. Further, the degree of the concentration of stress is expressed by stress concentration factor α. Although not illustrated, given that the average stress at the smallest cross-sectional portion is σ0 and the maximum stress is σm, the stress concentration factor is defined as stress concentration factor α=σm/σ0.

In a case in which the above-described through-holes 32, 33 approximate oval holes, the direction in which tensile load is applied is the vehicle vertical direction, the length of the long axis of the oval is a and the length of the short axis is b, and the maximum stress am that arises at the edge of the through-hole 32, 33 is determined by σm=σ0(1+2(a/b)). Namely, α is expressed as α=(1+2(a/b)). Here, it can be understood that, when a/b is small, i.e., when the length in the vehicle vertical direction is longer than the length in the vehicle transverse direction as in the case of the through-holes 32, 33 of the present embodiment, the stress concentration factor α is small, and the concentrations of stress that arise at the edges of the through-holes 32, 33 are small.

Further, at the vehicle side portion structure 20, the through-holes 32, 33 are formed at positions that overlap the neutral plane M. In a vicinity of the neutral plane M, the stress that is applied to the outer R/F 28 is zero or is extremely small, and therefore, it is difficult for the outer R/F 28 to deform. Namely, when the cracks K, that arise at the vehicle transverse direction inner side end edges of the outer R/F 28 at the time of a side collision, reach the through-holes 32, 33, not only is the progression of the cracks suppressed due to the through-holes 32, 33, but also, deformation of the edges of the through-holes 32, 33 is suppressed. Due thereto, deformation of the outer R/F 28 is suppressed, and therefore, deformation of the center pillar 22 toward the vehicle cabin inner side at the time of a side collision can be suppressed.

The characteristic of the vehicle side portion structure 20 (see FIG. 4) is shown by graph G1 in FIG. 8A. From the time of the side collision until the displacement amount d1, a reaction force that is greater than or equal to those of comparative example 1 and comparative example 2 is obtained at the vehicle side portion structure 20 due to the above-described operations. Moreover, at the vehicle side portion structure 20, even after the displacement amount becomes d1 and breakage arises at portions of the outer R/F 28 (see FIG. 7), reaction force is sustained by the pillar outer panel 24 and the pillar inner panel 26, and therefore, a reaction force that is higher than those of comparative example 1 and comparative example 2 is obtained.

The characteristic of the vehicle side portion structure 20 (see FIG. 4) is shown by graph G4 in FIG. 8B. Note that graph G7 illustrates the characteristic at the vehicle 12 overall (see FIG. 1). At the vehicle side portion structure 20, in the initial stage of a side collision (until time point T1), a high reaction force is obtained, and further, the reaction force is sustained even in the middle stage of the side collision and thereafter. Thus, the speed of deformation of the center pillar 22 (see FIG. 7) is less than or equal to those of comparative example 1 and comparative example 2. Concretely, given that, at time point T1, the speed of deformation of the vehicle body 12 is V1, the speed of deformation of the center pillar 22 of the vehicle side portion structure 20 is V2, the speed of deformation of comparative example 2 is V3, and the speed of deformation of comparative example 1 is V4, the relationship V1<V2<V3<V4 is established.

### Modified Examples

Note that the present invention is not limited to the above-described embodiment.

The outer R/F 28 is not limited to a “high tensile strength steel sheet”, and may be structured from an “ultrahigh tensile strength steel sheet” or a “hot stamped material”. A hot stamped material is formed by hot pressing that presses a steel sheet while heating it, and strength and ductility of the same extent as those of a high tensile strength steel sheet are obtained. Further, the outer R/F 28 may be structured such that the through-hole 32 is formed in the vertical wall portion 28B and a through-hole is not formed in the vertical wall portion 28C. Moreover, the outer R/F 28 may be structured such that the through-hole 33 is formed in the vertical wall portion 28C and a through-hole is not formed in the vertical wall portion 28B. In addition, the outer R/F 28 is not limited to the entirety thereof contacting the pillar outer panel 24, and may be such that only the regions that are joined by welding or the like contact the pillar outer panel 24.

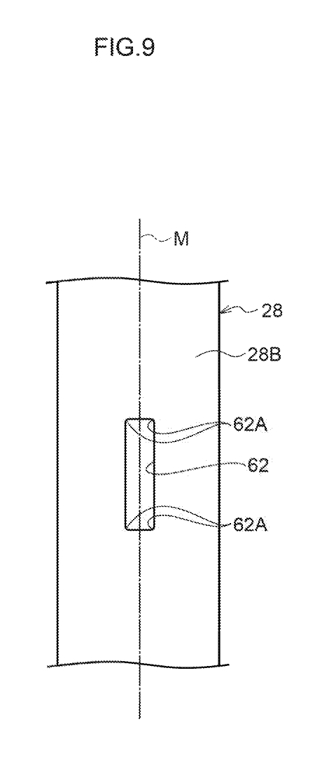

Further, the thickness (the plate thickness) of the outer R/F 28 may be greater than or equal to the thicknesses of the pillar outer panel 24 and the pillar inner panel 26, or may be less than or equal to these thicknesses. The shape of the through-holes that are formed in the outer R/F 28 are not limited to shapes that are near to oval as seen in the vehicle longitudinal direction, such as the through-holes 32, 33 (see FIG. 4, FIG. 5). For example, as shown in FIG. 9, through-holes 62 that are near to rectangular may be formed. Note that in a case in which the through-holes are made to be shapes that are near rectangular as shown in FIG. 9, it is preferable that curved portions 62A be formed at the four corners (the comer portions) from the standpoint of suppressing a concentration of stress.

It is preferable that the through-holes 32, 33 be formed so as to match the vehicle vertical direction position (the height) of the region, that is easiest to deform at the time of a side collision, at the center pillar 22. Further, in a case in which there are, at the center pillar 22, plural regions that are easiest to deform at the time of a side collision, the through-holes 32, 33 are not limited to being formed at one place in the vehicle vertical direction, and may be formed at plural places. Moreover, the through-holes 32, 33 are not limited to being formed at one place in the vehicle transverse direction, and may be formed at plural places.

In addition, the through-holes 32, 33 are not limited to holes at which the length L2 in the vehicle vertical direction is longer than the length L1 in the vehicle transverse direction, as seen in the vehicle longitudinal direction. For example, in a case in which the length of the outer R/F 28 in the vehicle transverse direction is sufficiently long as compared with the length of the through-holes, the through-holes may be through-holes at which the length L1 is longer than the length L2. Or, circular through-holes may be formed with the length L1=the length L2.

The side airbag of the vehicle 10 is not limited to being accommodated in the door side as is the side airbag 50, and may be accommodated in the vehicle seat 15 side. For example, there may be a structure in which a side airbag is accommodated in the side portion (the outer side) in the seat transverse direction (the vehicle transverse direction) of the vehicle seat 15, and the side airbag can inflate and expand due to the side portion of the vehicle seat 15 rupturing at the time of a side collision.

Although vehicle side portion structures relating to an embodiment and modified examples of the present invention have been described above, these embodiment and modified examples may be used by being combined appropriately, and the present invention can, of course be embodied in various forms within a scope that does not depart from the gist thereof.

What is claimed is:

1. A vehicle side portion structure comprising:
a pillar at which a closed cross-section is formed by a pillar inner and a pillar outer that are structured by ordinary steel plates that are each ductile; and
a reinforcing member that is structured by a member having a strength that is higher than and a ductility is lower than a strength and ductility of each of the pillar inner and the pillar outer, and that has a front wall disposed at a front side in a vehicle longitudinal direction and a rear wall disposed at a rear side in the vehicle longitudinal direction, and, in at least one of the front wall or the rear wall, a hole portion that passes-through the reinforcing member in the vehicle longitudinal direction being formed at a position that is further toward a lower side in a vehicle vertical direction than a beltline of a vehicle and that overlaps a neutral plane that runs along the vehicle longitudinal direction in a planar cross-section that includes the front wall and the rear wall, and the reinforcing member being joined to the pillar outer at an interior of the closed cross-section and reinforcing the pillar outer.

2. The vehicle side portion structure of claim 1, wherein a length of the hole portion in the vehicle vertical direction is longer than a length of the hole portion in a vehicle transverse direction, as seen in the vehicle longitudinal direction.

3. The vehicle side portion structure of claim 1, wherein:
a side airbag, that inflates and expands at a time of a side collision, is accommodated in a side door or in a seat transverse direction side portion of a vehicle seat, and
in a case in which the side airbag inflates and expands, the side airbag is disposed between the pillar and a side portion of a vehicle occupant who is seated in the vehicle seat.

4. The vehicle side portion structure of claim 1, wherein, the reinforcing member is joined to the pillar outer at a region further toward the vehicle transverse direction inner side than the hole portion.
